(19) United States
(12) Patent Application Publication
(10) Pub. No.: US 2019/0005478 A1
(43) Pub. Date: Jan. 3, 2019

(54) METHOD AND SYSTEM FOR OFFLINE DIGITAL EXCHANGES VIA CELLULAR COMMUNICATION

(71) Applicant: Mastercard International Incorporated, Purchase, NY (US)

(72) Inventors: Vipul MEHROTRA, Haryana (IN); Jaipal Singh KUMAWAT, Sikar (IN); Gaurav KUMAR, Gujarat (IN)

(73) Assignee: Mastercard International Incorporated, Purchase, NY (US)

(21) Appl. No.: 15/640,718

(22) Filed: Jul. 3, 2017

(51) Int. Cl. G06Q 20/20; H04W 4/00; H04W 4/14; G06F 17/30; G06Q 20/36

(52) U.S. Cl. CPC G06Q 20/202; H04W 4/008; G06Q 20/36; G06Q 20/204; G06F 17/30864; H04W 4/14

(57) ABSTRACT

A method for an offline data exchange for an electronic transaction includes: storing, in a memory of a computing device, at least an available balance and an account identifier; receiving, by an input device of the computing device, a user instruction including at least a transaction amount less than or equal to the available balance; establishing, by a communication interface of the computing device, a communication channel with a point of sale device using a first communication method; receiving, by a receiving device of the computing device, a merchant identifier using the first communication method; generating, by a generation module of the computing device, a data message including at least the transaction amount, the account identifier, and the merchant identifier; and electronically transmitting, by a transmitting device of the computing device, the generated data message to an external computing system using a second communication method.

### FIELD

The present disclosure relates to the performing of digital exchanges without an Internet connection using alternative communication methods, specifically the conducting of a transaction between a computing device and a point of sale device without the use of an Internet connection.

### BACKGROUND

In recent times, consumers have become largely inseparable from their cellular phones, smart phones, and other such computing devices. In an effort to take advantage of this growing relationship, computing devices are often improved to perform additional functions and be of greater use to consumers. One area where computing devices have improved is payment transactions, where electronic wallets have been developed, enabling a computing device to be used to convey payment details to a point of sale device in place of a traditional wallet.

However, existing electronic wallets are limited in design to require an active connection to the Internet, either directly or via a separate communication channel (e.g., a local area network, cellular communication network, etc.). In many cases, a consumer may be in an area that lacks a capable Internet connection, rendering their electronic wallet limited in use or unusable entirely. As a result, some methods have been developed to enable an electronic wallet to be used when lacking a connection to any external communication network.

However, these methods rely on the computing device to save all transaction information, which is eventually synchronized with the issuing institution once communication is established. In cases where the computing device may be used for a significant number of transactions before communication is established, the issuing institution may be overwhelmed with transactions to process, which may be detrimental to their computing system. Furthermore, a complete lack of communication between the computing device and the issuing institution results in the issuing institution being unaware of transactions for a significant period of time, which may negatively affect settlement and thus the relationship between the issuing institution and various merchants. These are technical issues the common solutions encounter.

Thus, there is a need for a technical solution to enable a computing device to be used as part of an electronic payment transaction while still keeping the issuing institution apprised, even in instances without an active Internet connection.

### SUMMARY

The present disclosure provides a description of systems and methods for offline data exchanges for electronic messages for conducting transactions without using the Internet or the like. The systems and methods discussed herein utilize multiple non-Internet communication channels for a computing device to participate in an electronic transaction with a point of sale device, while still informing the issuing institution of necessary data with regards to the transaction. Therefore, the issuing institution 108 can perform accounting and settlement and other functions while awaiting an opportunity to synchronize with the computing device. As a result, the computing resources of the issuing institution 108 may be improved, settlement between issuing institutions, acquiring institutions, and merchants can be improved, and consumers may be able to conduct payment transactions via a computing device while lacking an active Internet connection.

A method for an offline data exchange for an electronic transaction includes: storing, in a memory of a computing device, at least an available balance and an account identifier; receiving, by an input device of the computing device, a user instruction including at least a transaction amount less than or equal to the available balance; establishing, by a communication interface of the computing device, a communication channel with a point of sale device using a first communication method; receiving, by a receiving device of the computing device, a merchant identifier using the first communication method; generating, by a generation module of the computing device, a data message including at least the transaction amount, the account identifier, and the merchant identifier; and electronically transmitting, by a transmitting device of the computing device, the generated data message to an external computing system using a second communication method.

A system for an offline data exchange for an electronic transaction includes: a memory of a computing device configured to store at least an available balance and an account identifier; an input device of the computing device configured to receive a user instruction including at least a transaction amount less than or equal to the available balance; a communication interface of the computing device configured to establish a communication channel with a point of sale device using a first communication method; a receiving device of the computing device configured to receive a merchant identifier using the first communication method; a generation module of the computing device configured to generate a data message including at least the transaction amount, the account identifier, and the merchant identifier; and a transmitting device of the computing device configured to electronically transmit the generated data message to an external computing system using a second communication method.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for offline data exchanges for electronic transactions in accordance with exemplary embodiments.

FIG. 2 is a block diagram illustrating the computing device of the system of FIG. 1 for performing offline data exchanges with a point of sale device for electronic transactions in accordance with exemplary embodiments.

FIGS. 3A and 3B are a flow diagram illustrating a process for the performing of an offline data exchange for an electronic transaction and synchronization thereof in the system of FIG. 1 in accordance with exemplary embodiments.

FIG. 4 is a flow chart illustrating an exemplary method for an offline data exchange for an electronic transaction in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Point of Sale—A computing device or computing system configured to receive interaction with a user (e.g., a consumer, employee, etc.) for entering in transaction data, payment data, and/or other suitable types of data for the purchase of and/or payment for goods and/or services. The point of sale may be a physical device (e.g., a cash register, kiosk, desktop computer, smart phone, tablet computer, etc.) in a physical location that a customer visits as part of the transaction, such as in a “brick and mortar” store, or may be virtual in e-commerce environments, such as online retailers receiving communications from customers over a network such as the Internet. In instances where the point of sale may be virtual, the computing device operated by the user to initiate the transaction or the computing system that receives data as a result of the transaction may be considered the point of sale, as applicable.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Network/Payment Processor—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

### System for Offline Data Exchanges for Electronic Transactions

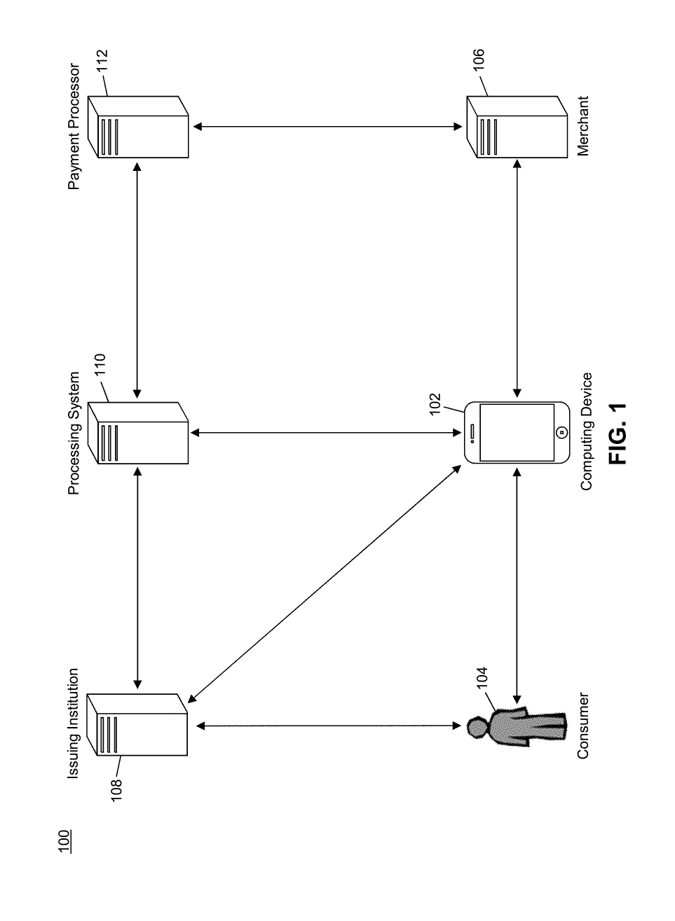

FIG. 1 illustrates a system 100 for the performing of offline data exchanges between a computing device and a point of sale device of a merchant for use in electronic payment transactions conducted without the computing device having an active Internet connection.

The system 100 may include a computing device 102. The computing device 102, discussed in more detail below, may be configured to participate in an offline data exchange for use in an electronic payment transaction without having an active connection to the Internet. The computing device 102 may be any type of computing device that is specifically configured to perform the functions discussed herein, such as a specifically configured cellular phone, smart phone, smart watch, wearable computing device, implantable computing device, laptop computer, notebook computer, tablet computer, etc. In the system 100, a consumer 104 may be a user of the computing device 102 and wish to use the computing device 102 to participate in an electronic payment transaction at a merchant 106.

The consumer 104 may have access to a transaction account issued by an issuing institution 108 for use in funding electronic payment transactions. The issuing institution 108 may be a financial institution, such as an issuing bank, or any other suitable entity configured to issue transaction accounts for use in funding electronic payment transactions. The issuing institution 108 may issue the transaction account for which the consumer 104 is an authorized user, and, as part of the issuing of the transaction account, may provision payment credentials to the computing device 102. Payment credentials may be comprised of a transaction account number and any other data that is used in the processing of a payment transaction funded thereby, such as an expiration date, name, billing address, security code, transaction counter, payment cryptogram, etc. In some embodiments, the payment credentials may be used for a plurality of payment transactions with an expiration date. In other embodiments, the payment credentials may be generated or otherwise usable via a single use key or other mechanism for using the payment credentials for one or a predetermined number of transactions.

As part of the issuance of the transaction account, the issuing institution 108 may establish an account balance for the transaction account, which may be a balance indicating the amount of money remaining in or otherwise usable by (e.g., via credit) the transaction account for payment transactions. In addition to the account balance, the issuing institution 108 may identify a balance available for offline transactions, also referred to herein as an “available balance.” The issuing institution 108 may provide this information to the computing device 102, which may be configured to store at least the available balance in a memory or other storage thereof, as discussed in more detail below. For instance, the balance information may be provided directly to the computing device 102 along with the payment credentials and/or other transaction account data, or may be provided to the computing device 102 via a third party, such as an electronic wallet operator or provider.

The consumer 104 may use the computing device 102 at a merchant 106 to initiate an electronic payment transaction. In an exemplary embodiment, the computing device 102 may lack an active Internet connection during the initiation and initial processing of the electronic payment transaction. The computing device 102 may establish a communication channel with a point of sale device of the merchant 106. The communication channel may utilize suitable non-Internet communication method, such as near field communication, radio frequency, Bluetooth, etc. In some embodiments, the consumer 104 may input an instruction (e.g., via an interface displayed on the computing device 102, such as via an electronic application program) into the computing device 102 prior to establishing of the communication channel, indicating that an offline electronic payment transaction is to be performed.

Once the communication channel is established, the point of sale device may electronically transmit at least a merchant identifier to the computing device 102 using the established communication channel. The merchant identifier may be a unique value that is uniquely associated with the merchant 106 used for identification thereof, such as a merchant identification number, account number, routing number, etc. The computing device 102 may be configured to electronically transmit the payment credentials provisioned thereto to the point of sale device using the established communication channel. In some cases, the payment credentials may be provisioned prior to receipt of the merchant identifier. In other cases, the merchant identifier may be received before the payment credentials are provisioned to the point of sale device.

In some instances, the point of sale device may also electronically transmit a transaction amount for the payment transaction to the computing device 102 in addition to the merchant identifier. In such instances, the computing device 102 may determine if the available balance is at least equal to the transaction amount, to ensure that the available balance is not exceeded. If the transaction amount is too high, the computing device 102 may not provision the payment credentials to the point of sale device and proceed with the transaction.

Once the computing device 102 has transmitted the payment credentials to the point of sale device, the computing device 102 may generate a data message for the issuing institution 108. The data message may include data associated with the payment transaction, including at least the transaction amount, the account identifier associated with the transaction account, and the merchant identifier associated with the merchant 106. The computing device 102 may electronically transmit the data message to the issuing institution 108 using a suitable, non-Internet communication channel, which may utilize a different communication method than used to communicate with the point of sale device. In an exemplary embodiment, the data message may be electronically transmitted to the issuing institution 108 as a short messaging service (SMS) message, which may be electronically transmitted using a cellular communication network. In some cases, the computing device 102 may also electronically transmit an SMS message for the payment transaction to the merchant 106 as well as back to the computing device 102, which may serve as a record of the payment transaction. In some instances, the computing device 102 may use a native application program of the operating system of the computing device 102 for electronically transmitting the data message (e.g., via SMS).

Following its participation in the payment transaction and transmission of the SMS message, the computing device 102 may update the available balance stored in the computing device 102 to account for the payment transaction, such as by subtracting the transaction amount from the available balance. As a result, the computing device 102 may only be able to participate in offline electronic transactions up to the available amount identified by the issuing institution 108. In such cases, the issuing institution 108 may use the available amount to limit the capacity of the consumer 104 to conduct offline payment transactions, such as to reduce the likelihood of fraud for the issuing institution 108, consumer 104, and merchants 106.

After the point of sale device of the merchant 106 receives the payment credentials from the computing device 102, the merchant 106 may electronically transmit transaction data for the payment transaction to a payment processor 112 for processing of the payment transaction. The transaction data may include at least the transaction amount, payment credentials, and any other data necessary for processing of the payment transaction, such as a transaction time, transaction date, currency type, product data, offer data, reward data, loyalty data, etc. The merchant 106 may electronically transmit the transaction data directly to the payment processor 112 via payment rails associated therewith or via one or more intermediate entities, such as an acquiring institution or a gateway processor. The payment processor 112 may then process the payment transaction using traditional methods and systems.

Once the computing device 102 re-established an Internet connection, the computing device 102 may establish a communication channel with the issuing institution 108 via the Internet. In some embodiments, the computing device 102 may electronically transmit the data message to the issuing institution 108 via the Internet communication channel, such as to serve as confirmation of the transaction as indicated via the SMS message. In some such embodiments, the issuing institution 108 may have approved the payment transaction during initial processing (e.g., by the payment processor 112), and may use the new data message as confirmation to proceed with clearing and settlement of the transaction. In other such embodiments, the issuing institution 108 may wait to approve the payment transaction until such a confirmation is received. In some instances, the merchant 106 may await processing of the payment transaction until the issuing institution 108 receives the data message via the Internet communication channel. In such instances, the issuing institution 108 may (e.g., via the payment processor 112, an intermediate entity, or other third party) notify the merchant 106 of the confirmation, at which time the merchant 106 may submit the payment transaction to the payment processor 112.

Using the established Internet communication channel, the issuing institution 108 may electronically transmit a confirmation message to the computing device 102, confirming the processing of the payment transaction. In some cases, the issuing institution 108 may electronically transmit the confirmation message after receipt of the data message from the computing device 102 using the Internet communication channel. Once the computing device 102 has received the confirmation message from the issuing institution 108, the computing device 102 may update the available balance accordingly, such as by adding the transaction amount back into the available balance. As such, the confirmation message from the issuing institution 108 may include data indicating adjustments to the available balance, such as due to other transactions conducted via the transaction account, the result of the processing of the payment transaction, etc. After the computing device 102 receives the confirmation message and adjusts the available balance, the consumer 104 may continue utilizing the computing device 102 to conduct additional payment transactions, both online and offline from the Internet.

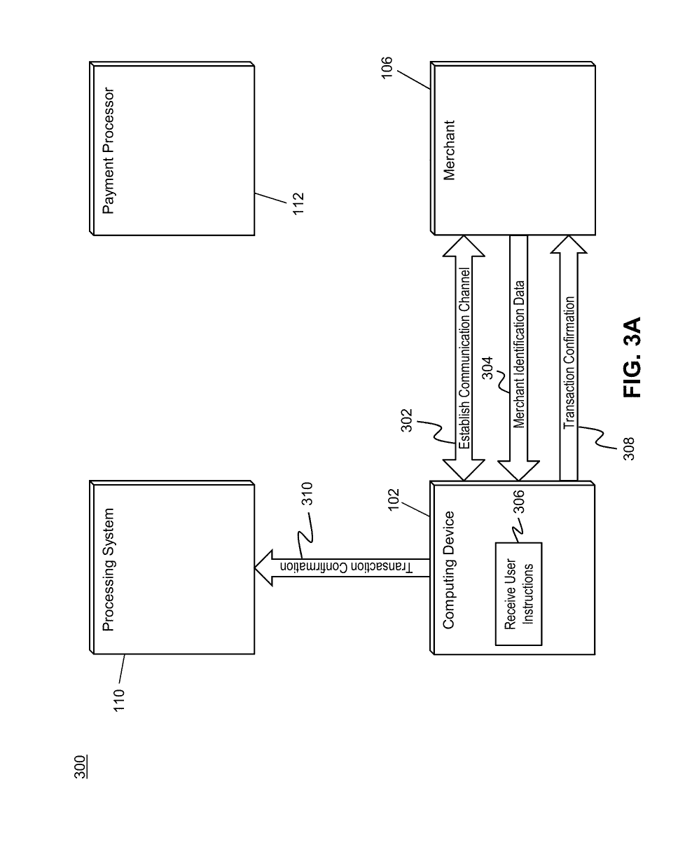

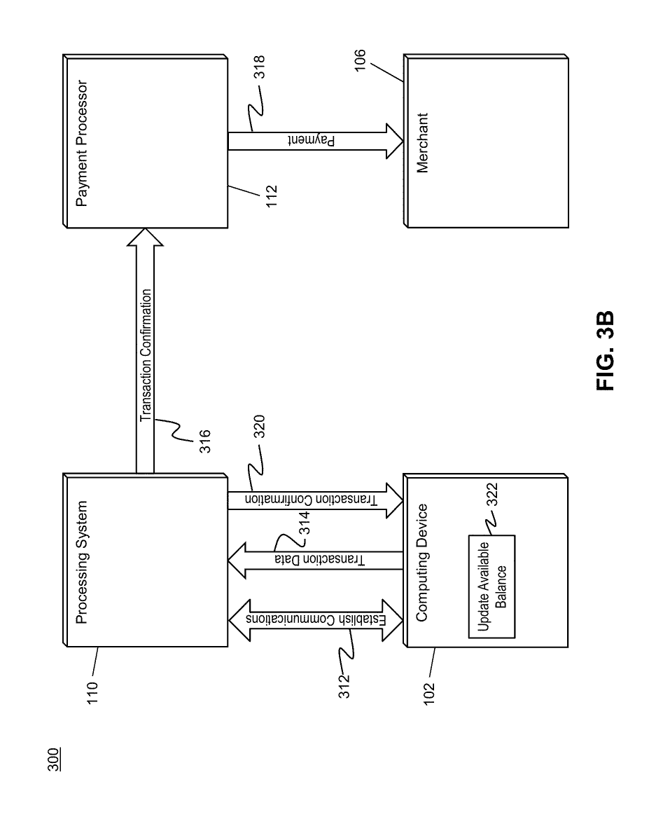

In some embodiments, the system 100 may also include a processing system 110. The processing system 110 may serve as an intermediary between the issuing institution 108 and the computing device 102, to serve functions of the issuing institution 108 on behalf thereof. For instance, the processing system 110 may be configured to maintain the available balances of transaction accounts, receive and process confirmation messages, distribute confirmation messages to computing devices 102, etc. In such embodiments, the processing system 110 may be of a third party entity, which may be configured to perform such functions as to enable issuing institutions 108 to offer the services provided by the systems and methods discussed herein using their existing hardware infrastructure. In these embodiments, the processing system 110 may be configured to perform any function attributed to the issuing institution 108 as discussed herein, such as illustrated in the system 300 in FIGS. 3A and 3B, discussed in more detail below.

The methods and systems discussed herein may thus enable for offline data exchanges between the specifically configured computing device 102 and a merchant 106 as part of an electronic payment transaction without the use of an Internet connection. The use of an available balance may ensure that the consumer 104 does not exceed limits set by the issuing institution 108 for use of the transaction account, while still enabling the consumer 104 to take advantage of offline transactions. In addition, the use of SMS messages and other alternative forms of communications discussed herein enable the computing device 102 to ensure that relevant transaction data is provided to the issuing institution 108 despite the lack of an Internet connection, to enable the issuing institution 108 to perform processing functions ahead of final confirmation of the payment transaction, which can help manage processing resources, account settlement, and other functions of the issuing institution 108 that may be unavailable for computing devices 102 that lack any connection to an external communication network.

### Computing Device

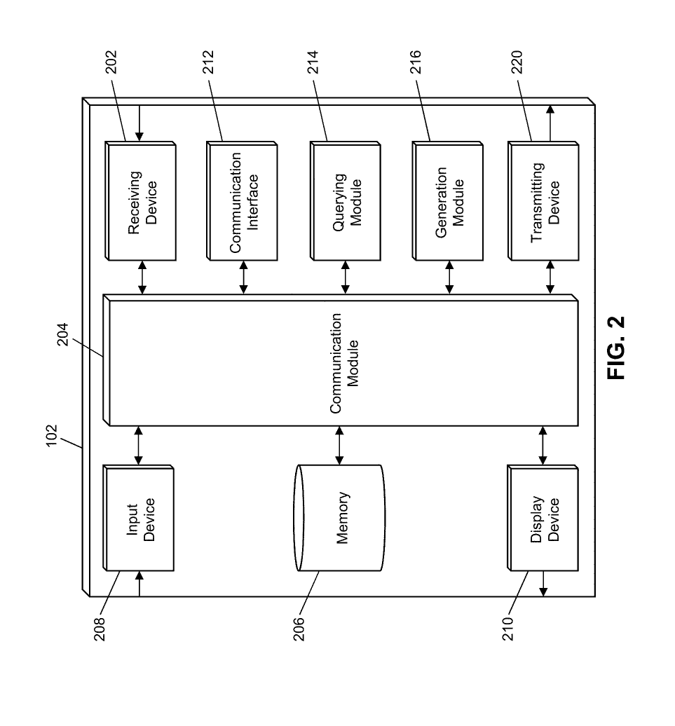

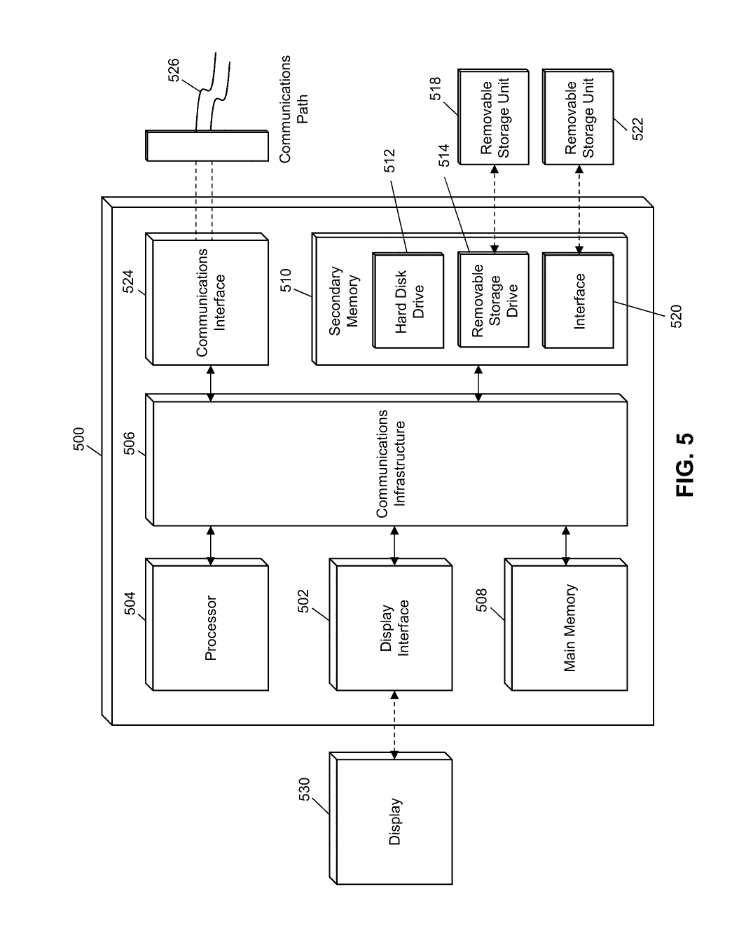

FIG. 2 illustrates an embodiment of a computing device 102 in the system 100. It will be apparent to persons having skill in the relevant art that the embodiment of the computing device 102 illustrated in FIG. 2 is provided as illustration only and may not be exhaustive to all possible configurations of the computing device 102 suitable for performing the functions as discussed herein. For example, the computer system 500 illustrated in FIG. 5 and discussed in more detail below may be a suitable configuration of the computing device 102.

The computing device 102 may include a receiving device 202. The receiving device 202 may be configured to receive data over one or more networks via one or more network protocols. In some instances, the receiving device 202 may be configured to receive data from merchants 106, issuing institutions 108, processing systems 110, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by merchants 106 (e.g., by point of sale devices thereof), which may be superimposed or otherwise encoded with merchant identifiers and, in some cases, transaction data, such as a transaction amount. The receiving device 202 may also be configured to receive data signals superimposed or otherwise encoded with payment credentials, balance data, and other information associated with a transaction account, such as may be electronically transmitted by issuing institutions 108 and/or processing systems 110. The receiving device 202 may be further configured to receive data signals superimposed or otherwise encoded with a confirmation message related to a payment transaction, such as may be electronically transmitted by issuing institutions 108 and/or processing systems 110.

The computing device 102 may also include a communication module 204. The communication module 204 may be configured to transmit data between modules, engines, databases, memories, and other components of the computing device 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the computing device 102 and external components of the computing device 102, such as externally connected databases, display devices, input devices, etc. The computing device 102 may also include a processing device. The processing device may be configured to perform the functions of the computing device 102 discussed herein as will be apparent to persons having skill in the relevant art. In some embodiments, the processing device may include and/or be comprised of a plurality of engines and/or modules specially configured to perform one or more functions of the processing device, such as a communication interface 212, querying module 214, generation module 216, etc. As used herein, the term “module” may be software or hardware particularly programmed to receive an input, perform one or more processes using the input, and provides an output. The input, output, and processes performed by various modules will be apparent to one skilled in the art based upon the present disclosure.

The computing device 102 may also include a memory 206. The memory 206 may be configured to store data for use by the computing device 102 in performing the functions discussed herein, such as public and private keys, symmetric keys, etc. The memory 206 may be configured to store data using suitable data formatting methods and schema and may be any suitable type of memory, such as read-only memory, random access memory, etc. The memory 206 may include, for example, encryption keys and algorithms, communication protocols and standards, data formatting standards and protocols, program code for modules and application programs of the processing device, and other data that may be suitable for use by the computing device 102 in the performance of the functions disclosed herein as will be apparent to persons having skill in the relevant art. In some embodiments, the memory 206 may be comprised of or may otherwise include a relational database that utilizes structured query language for the storage, identification, modifying, updating, accessing, etc. of structured data sets stored therein. The memory 206 may be configured to store, for example, application program data for an electronic wallet application configured to provide an interface to the consumer 104 for use of the transaction account in offline transactions. The memory 206 may also be configured to store at least payment credentials and an available balance associated with a transaction account.

The computing device 102 may also include or be otherwise interfaced with one or more input devices 208. The input devices 208 may be internal to the computing device 102 or external to the computing device 102 and connected thereto via one or more connections (e.g., wired or wireless) for the transmission of data to and/or from. The input devices 208 may be configured to receive input from a user of the computing device 102, which may be provided to another module or engine of the computing device 102 (e.g., via the communication module 204) for processing accordingly. Input devices 208 may include any type of input device suitable for receiving input for the performing of the functions discussed herein, such as a keyboard, mouse, click wheel, scroll wheel, microphone, touch screen, track pad, camera, optical imager, etc. The input device 208 may be configured to, for example, receive input by the consumer 104 requesting to proceed with an offline data exchange, and, in some instances, may receive input of a transaction amount by the consumer 104.

The computing device 102 may also include or be otherwise interfaced with a display device 210. The display device 210 may be internal to the computing device 102 or external to the computing device 102 and connected thereto via one or more connections (e.g., wired or wireless) for the transmission of data to and/or from. The display device 210 may be configured to display data to a user of the computing device 102. The display device 210 may be any type of display suitable for displaying data as part of the functions discussed herein, such as a liquid crystal display, light emitting diode display, thin film transistor display, capacitive touch display, cathode ray tube display, light projection display, etc. In some instances, the computing device 102 may include multiple display devices 210. The display device 210 may be configured to, for example, display an interface to the consumer 104 for utilizing an electronic wallet, including the display of SMS messages, transaction account selections, entry forms for offline data exchanges, etc.

The computing device 102 may also include a communication interface 212. The communication interface 212 may provide for input and output from the computing device 102 and a plurality of different communication networks, utilizing the appropriate communication protocols and instructions necessary for communication therewith. The communication interface may be configured to establish a communication channel with a point of sale device using a first communication method for the exchange of communications therewith, may be configured to transmit communications to an issuing institution 108 and/or processing system 110 via a second communication method, and may be configured to establish a communication channel with an issuing institution 108 and/or processing system 100 using a third communication method that utilizes the Internet. In some instances, the second communication method may be the short messaging service.

The computing device 102 may include a querying module 214. The querying module 214 may be configured to execute queries on databases to identify information. The querying module 214 may receive one or more data values or query strings, and may execute a query string based thereon on an indicated database, such as the memory 206, to identify information stored therein. The querying module 214 may then output the identified information to an appropriate engine or module of the computing device 102 as necessary. The querying module 214 may, for example, execute a query on the memory 206 to identify payment credentials and an associated available balance stored therein, for electronic transmission to a point of sale device, to update the available balance stored therein, etc.

The computing device 102 may also include a generation module 216. The generation module 216 may be configured to generate data for use in performing the functions of the computing device 102 as discussed herein. The generation module 216 may receive instructions as to data to generate as input, may generate the data as instructed, and may output the generated data to another module or engine of the computing device 102. For example, the generation module 216 may be configured to generate data messages, which may be electronically transmitted via suitable communication methods, such as the generation of an SMS message for electronic transmission to an issuing institution 108, or a data message for transmission to the issuing institution 108 via the Internet.

The computing device 102 may also include a transmitting device 220. The transmitting device 220 may be configured to transmit data over one or more networks via one or more network protocols. In some instances, the transmitting device 220 may be configured to transmit data to merchants 106, issuing institutions 108, processing systems 110, and other entities via one or more communication methods, local area networks, wireless area networks, cellular communication, Bluetooth, radio frequency, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data via the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to point of sale devices of merchants 106 that are superimposed or otherwise encoded with payment credentials. The transmitting device 220 may also be configured to electronically transmit data signals to issuing institutions 108 and/or processing systems 110 superimposed or otherwise encoded with SMS messages that include account identifiers, transaction amounts, and merchant identifiers. The transmitting device 220 may also be configured to electronically transmit data signals to issuing institutions 108 and/or processing systems 110 that are superimposed or otherwise encoded with data messages including account identifiers, transaction amounts, merchant identifiers, and any other transaction data that may be transmitted via the Internet.

### Process for Offline Data Exchange for Electronic Payment Transactions

FIGS. 3A and 3B illustrate a process 300 for the exchange of data for an electronic payment transaction including the exchange of data between the computing device 102 and a point of sale device of the merchant 106 for initial processing of a payment transaction without the computing device 102 having an active Internet connection.

In step 302, the communication interface 212 of the computing device 102 may establish a communication channel with the merchant 106 (e.g., a point of sale device thereof) using a first communication method, such as near field communication, radio frequency, Bluetooth, etc. In step 304, the merchant 106 may electronically transmit a merchant identifier associated therewith to the computing device 102 via the established communication channel, which may be received by the receiving device 202 of the computing device 102 via the communication interface 212 thereof. In some cases, the merchant identifier may be accompanied by a transaction amount and any other transaction data. In step 306, the input device 208 of the computing device 102 may receive input from the consumer 104 indicating instructions to proceed with the offline transaction, which may include input and/or confirmation of the transaction amount.

In step 308, the transmitting device 220 of the computing device 102 may electronically transmit a confirmation message to the merchant 106 via the established communication channel, which may confirm the offline payment transaction for the transaction amount. The merchant 106 may then be free to process the payment transaction using suitable methods and systems, such as by transmitting transaction data, including the transaction amount and payment credentials, to the payment processor 112 via payment rails associated therewith. In step 310, the transmitting device 220 of the computing device 102 may electronically transmit a data message confirming the transaction to the processing system 110 using a separate communication channel, such as the short messaging service. The data message may include at least the account identifier associated with the transaction account used to fund the payment transaction, and the merchant identifier and transaction amount included in the transaction data. The processing system 110 may inform the issuing institution 108 of the offline transaction, and any processing of the payment transaction may take place between the issuing institution 110 and payment processor 112 as necessary.

Once the computing device 102 has re-established communication with the Internet, then, in step 312, the communication interface 212 of the computing device 102 may establish a communication channel with the processing system 110 via the Internet. Following the establishing of the channel, then, in step 314, the transmitting device 220 of the computing device 102 may electronically transmit transaction data for the payment transaction to the processing system 110 using the established communication channel. In some embodiments, the transaction data may be comprised of the same data transmitted via the SMS message following the offline data exchange. In other embodiments, the transaction data may include additional data associated with the transaction, such as may have been input by the consumer 104, identified by the computing device 102 (e.g., time, geographic location, date, etc.), or provided by the merchant 106 using the first communication channel.

In step 316, the processing system 110 may confirm that the transaction that was processed matches the transaction data provided by the computing device 102, such as to ensure that the merchant 106 did not tamper with the transaction amount or any other transaction data, and, if the transaction is confirmed, may electronically transmit a confirmation of the transaction to the payment processor 112. With the transaction confirmed, then, in step 318, the payment processor 112 may initiate payment of the transaction amount to the merchant 106. For instance, the payment processor 112 may inform the merchant's acquiring institution of the confirmation such that the acquiring institution will release funds to the merchant 106, may contact the issuing institution 108 for settlement with the acquiring institution, etc.

In step 320, the processing system 110 may electronically transmit a confirmation to the computing device 102, for receipt by the receiving device 202 thereof, which may confirm the processing of the payment transaction. In step 322, the querying module 214 of the computing device 102 may execute a query on the memory 206 of the computing device 102 to update the available balance based on the processed transaction, such as by increasing the available balance by the transaction amount. In some cases, the confirmation received from the processing system 110 may include data used by the querying module 214 in updating the available balance.

### Exemplary Method for an Offline Data Exchange for an Electronic Transaction

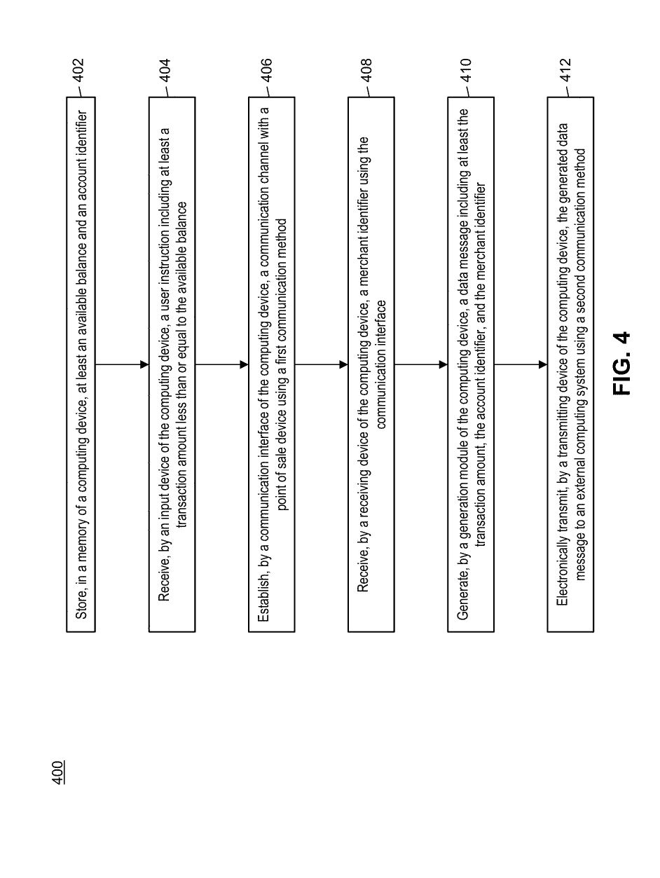

FIG. 4 illustrates a method 400 for the conducting of a data exchange between a computing device and a point of sale device to be confirmed by an additional computing system without an active Internet connection of the computing device.

In step 402, at least an available balance and an account identifier may be stored in a memory (e.g., the memory 206) of a computing device (e.g., the computing device 102). In step 404, a user instruction may be received by an input device (e.g., the input device 208) of the computing device, wherein the user instruction includes at least a transaction amount that is less than or equal to the available balance. In step 406, a communication channel may be established by a communication interface (e.g., the communication interface 212) of the computing device with a point of sale device (e.g., of the merchant 106) using a first communication method.

In step 408, a merchant identifier may be received by a receiving device (e.g., the receiving device 202) of the computing device using the first communication method. In step 410, a data message may be generated by a generation module (e.g., the generation module 216) of the computing device, wherein the data message includes at least the transaction amount, the account identifier, and the merchant identifier. In step 412, the generated data message may be electronically transmitted by a transmitting device (e.g., the transmitting device 220) of the computing device to an external computing system (e.g., the issuing institution 108, processing system 110, etc.) using a second communication method.

In one embodiment, the establishing, receiving, generating, and electronically transmitting steps may be conducted by the computing device without utilizing a connection to Internet. In some embodiments, the first communication method may be a near field communication. In one embodiment, the second method of communication may be short messaging service. In some embodiment, the generated data message may be electronically transmitted to a financial institution (e.g., the issuing institution 108) associated with a transaction account corresponding to the account identifier. In one embodiment, the method 400 may further include: generating, by the generation module of the computing device, a second data message including at least the transaction amount and the merchant identifier; and electronically transmitting, by the transmitting device of the computing device, the generated second data message to the computing device using the second communication channel.

In some embodiments, the method 400 may also include: establishing, by the communication interface of the computing device, a connection to Internet; establishing, by the communication interface of the computing device, a communication channel with the external computing system using the connection to Internet; and electronically transmitting, by the transmitting device of the computing device, an additional data message including at least the transaction amount, the account identifier, and the merchant identifier to the external computing system using the established communication channel with the external computing system. In one embodiment, the method 400 may further include: establishing, by the communication interface of the computing device, a connection to Internet; establishing, by the communication interface of the computing device, a communication channel with the external computing system using the connection to Internet; receiving, by the receiving device of the computing device, a transaction notification from the external computing system using the established communication channel, wherein the transaction notification indicates at least successful processing of a transaction for the transaction amount; and executing, by a querying module (e.g., the querying module 214) of the computing device, a query on the memory of the computing device to update the available balance based at least on the transaction amount.

### Computer System Architecture

FIG. 5 illustrates a computer system 500 in which embodiments of the present disclosure, or portions thereof, may be implemented as computer-readable code. For example, the computing device 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3A, 3B, and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for offline data exchanges for an electronic transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for an offline data exchange for an electronic transaction, comprising:
storing, in a memory of a computing device, at least an available balance and an account identifier;
receiving, by an input device of the computing device, a user instruction including at least a transaction amount less than or equal to the available balance;
establishing, by a communication interface of the computing device, a communication channel with a point of sale device using a first communication method;
receiving, by a receiving device of the computing device, a merchant identifier using the first communication method;
generating, by a generation module of the computing device, a data message including at least the transaction amount, the account identifier, and the merchant identifier; and
electronically transmitting, by a transmitting device of the computing device, the generated data message to an external computing system using a second communication method.

2. The method of claim 1, wherein the establishing, receiving, generating, and electronically transmitting steps are conducted by the computing device without utilizing a connection to Internet.

3. The method of claim 1, wherein the first communication method is near field communication.

4. The method of claim 1, wherein the second method of communication is short messaging service.

5. The method of claim 1, wherein the generated data message is electronically transmitted to a financial institution associated with a transaction account corresponding to the account identifier.

6. The method of claim 1, further comprising:
generating, by the generation module of the computing device, a second data message including at least the transaction amount and the merchant identifier; and
electronically transmitting, by the transmitting device of the computing device, the generated second data message to the computing device using the second communication channel.

7. The method of claim 1, further comprising:
establishing, by the communication interface of the computing device, a connection to Internet;
establishing, by the communication interface of the computing device, a communication channel with the external computing system using the connection to Internet; and
electronically transmitting, by the transmitting device of the computing device, an additional data message including at least the transaction amount, the account identifier, and the merchant identifier to the external computing system using the established communication channel with the external computing system.

8. The method of claim 1, further comprising:
establishing, by the communication interface of the computing device, a connection to Internet;
establishing, by the communication interface of the computing device, a communication channel with the external computing system using the connection to Internet;
receiving, by the receiving device of the computing device, a transaction notification from the external computing system using the established communication channel, wherein the transaction notification indicates at least successful processing of a transaction for the transaction amount; and
executing, by a querying module of the computing device, a query on the memory of the computing device to update the available balance based at least on the transaction amount.

9. The method of claim 1, wherein the receiving and establishing steps are performed via an electronic wallet application program executed by the computing device.

10. The method of claim 1, wherein the electronic transmission using the second communication method is performed using a native application program of an operating system of the computing device.

11. A system for an offline data exchange for an electronic transaction, comprising:
a memory of a computing device configured to store at least an available balance and an account identifier;
an input device of the computing device configured to receive a user instruction including at least a transaction amount less than or equal to the available balance;
a communication interface of the computing device configured to establish a communication channel with a point of sale device using a first communication method;
a receiving device of the computing device configured to receive a merchant identifier using the first communication method;
a generation module of the computing device configured to generate a data message including at least the transaction amount, the account identifier, and the merchant identifier; and
a transmitting device of the computing device configured to electronically transmit the generated data message to an external computing system using a second communication method.

12. The system of claim 11, wherein the establishing, receiving, generating, and electronically transmitting steps are conducted by the computing device without utilizing a connection to Internet.

13. The system of claim 11, wherein the first communication method is near field communication.

14. The system of claim 11, wherein the second method of communication is short messaging service.

15. The system of claim 11, wherein the generated data message is electronically transmitted to a financial institution associated with a transaction account corresponding to the account identifier.

16. The system of claim 11, wherein
the generation module of the computing device is further configured to generate a second data message including at least the transaction amount and the merchant identifier; and
the transmitting device of the computing device is further configured to electronically transmit the generated second data message to the computing device using the second communication channel.

17. The system of claim 11, wherein
the communication interface of the computing device is further configured to
establish a connection to Internet, and
establish a communication channel with the external computing system using the connection to Internet, and
the transmitting device of the computing device is further configured to electronically transmit an additional data message including at least the transaction amount, the account identifier, and the merchant identifier to the external computing system using the established communication channel with the external computing system.

18. The system of claim 11, further comprising:
a querying module of the computing device, wherein
the communication interface of the computing device is further configured to
establish a connection to Internet, and
establish a communication channel with the external computing system using the connection to Internet;
the receiving device of the computing device is further configured to a transaction notification from the external computing system using the established communication channel, wherein the transaction notification indicates at least successful processing of a transaction for the transaction amount; and
the querying module of the computing device is configured to execute a query on the memory of the computing device to update the available balance based at least on the transaction amount.

19. The system of claim 11, wherein the receiving and establishing steps are performed via an electronic wallet application program executed by the computing device.

20. The system of claim 11, wherein the electronic transmission using the second communication method is performed using a native application program of an operating system of the computing device.
